(19) United States
(12) Patent Application Publication
(10) Pub. No.: US 2025/0161150 A1
(43) Pub. Date: May 22, 2025

(54) MALE SEXUAL STIMULATION DEVICE

(71) Applicant: Dongguan Mimao Electronic Technology Co., Ltd., Dongguan (CN)

(72) Inventor: Qinling Wang, Heyuan (CN)

(21) Appl. No.: 18/940,784

(22) Filed: Nov. 7, 2024

Related U.S. Application Data
(63) Continuation-in-part of application No. 18/516,984, filed on Nov. 22, 2023, now Pat. No. 12,161,598.

(51) Int. Cl. A61H 19/00; A61H 7/00; A61H 23/02

(52) U.S. Cl. CPC A61H 19/32; A61H 7/005; A61H 23/0254; A61H 2201/1215; A61H 2201/149; A61H 2201/1669; A61H 2201/1671; A61H 2201/1676; A61H 2205/087

(57) ABSTRACT

A male sexual stimulation device includes a first stimulation part with at least two swinging portions being opposite to each other, a second stimulation part including a rotary portion and a stimulation assembly. A first chamber is defined between the at least two swinging portions. A second chamber is defined in the rotary portion. The first chamber and the second chamber communicate with each other and cooperatively form an accommodating space for receiving a male genitalia therein. The stimulation assembly is connected to the at least two swinging portions and the rotary portion in a transmission way, configured for driving the at least two swinging portions to swing towards or away from each other and driving the rotary portion to rotate.

### CROSS-REFERENCE TO RELATED APPLICATIONS

This application is a continuation in part application of application Ser. No. 18/516,984, filed on Nov. 22, 2023, the entire contents of which are hereby incorporated by reference.

### TECHNICAL FIELD

The present application relates to the technical field of adult products, and in particular to a male sexual stimulation device.

### BACKGROUND

Male sexual stimulation device, such as masturbation cup, is a tool for simulating the female vaginal to allow males, particularly the bachelordom and long-distance separation males, to release their sex pressure, which satisfy their physiological and psychological needs to a certain extent.

Generally, the existing masturbation cup includes a cup holder and a hollow cup body connected to the cup holder. Functional members, such as vibration motors, are set in and/or around the cup body. During the sexual intercourse, male genitalia is inserted into the hollow cup body, and the vibration motors drive the cup body to vibrate in high frequency, thereby stimulating the male genitalia inside the cup body. However, a stimulation effect of such device is not good.

### SUMMARY

In view of this, an object of the present application is to provide a male sexual stimulation device with enhanced stimulation effect.

To achieve the above object, this application provides a male sexual stimulation device including:
a first stimulation part including at least two swinging portions being opposite to each other, a first chamber being defined between the at least two swinging portions;
a second stimulation part including a rotary portion defining a second chamber therein, the first chamber and the second chamber communicating with each other and cooperatively forming an accommodating space for receiving a male genitalia therein; and
a stimulation assembly connected to the at least two swinging portions and the rotary portion in a transmission way, configured for driving the at least two swinging portions to swing towards or away from each other and driving the rotary portion to rotate.

Compared with the prior art, the present male sexual stimulation device has two stimulation portions configured to stimulate the male genitalia inside the accommodating space in different manners, wherein the swinging portions clamp and pinch the male genitalia, while the rotary portion rotates to rub against the male genitalia, thus a stimulation effect of the present male sexual stimulation device is better, and the users are more likely to reach orgasm with the help of the present male sexual stimulation device.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is a schematic, assembled view of a male sexual stimulation device according to a first embodiment of the present application.

FIG. 2 is a top plan view of the male sexual stimulation device of FIG. 1.

FIG. 3 is a cross sectional view of the male sexual stimulation device taken along line III-III of FIG. 2.

FIG. 4 is a cross sectional view of the male sexual stimulation device taken along line IV-IV of FIG. 2.

FIG. 5 is a cross sectional view of the male sexual stimulation device taken along line V-V of FIG. 2.

FIG. 6 is an exploded view of the male sexual stimulation device of FIG. 1.

FIG. 7 is a further exploded view of the male sexual stimulation device of FIG. 1, wherein an outer shell and an upper portion of an inner shell are removed.

FIG. 8a is an exploded view of a first stimulation module of the male sexual stimulation device of FIG. 1.

FIG. 8b is an exploded view of the first stimulation module from another aspect.

FIG. 9a is a schematic view of an alternative embodiment of a swinging unit of the first stimulation module.

FIG. 9b is a schematic view of a third embodiment of the swinging unit.

FIG. 9c is a schematic view of a fourth embodiment of the swinging unit.

FIG. 9d is a schematic view of a fifth embodiment of the swinging unit.

FIG. 10a is an exploded view of a second stimulation module of the male sexual stimulation device of FIG. 1.

FIG. 10b is an exploded view of the second stimulation module from another aspect.

FIG. 11 is a schematic, assembled view of a male sexual stimulation device according to a second embodiment of the present application.

FIG. 12 is a top plan view of the male sexual stimulation device of FIG. 11.

FIG. 13 is a cross sectional view of the male sexual stimulation device taken along line XIII-XIII of FIG. 12.

FIG. 14 is a cross sectional view of the male sexual stimulation device taken along line XIV-XIV of FIG. 12.

FIG. 15 is a cross sectional view of the male sexual stimulation device taken along line XV-XV of FIG. 12.

FIG. 16 is an exploded view of the male sexual stimulation device of FIG. 11.

FIG. 17 is an exploded view of the male sexual stimulation device of FIG. 11 from another aspect.

FIG. 18 is a schematic view of a first stimulation module of the male sexual stimulation device of FIG. 11.

FIG. 19 shows the first stimulation module of FIG. 18 from another aspect.

FIG. 20 is an exploded view of the first stimulation module of FIG. 18.

FIG. 21 is a schematic view of a second stimulation module of the male sexual stimulation device of FIG. 11.

FIG. 22 is an exploded view of the second stimulation module of FIG. 21.

FIG. 23 is a schematic, assembled view of a male sexual stimulation device according to a third embodiment of the present application.

FIG. 24 is a schematic view of a stimulation assembly of the male sexual stimulation device of FIG. 23.

FIG. 25 is a schematic, exploded view of the stimulation assembly of FIG. 24.

FIG. 26 is a schematic, assembled view of a male sexual stimulation device according to a fourth embodiment of the present application.

FIG. 27 is an exploded view of the male sexual stimulation device of FIG. 26.

FIG. 28 is a further exploded view of a first stimulation module of the male sexual stimulation device of FIG. 27.

FIG. 29 is a schematic, assembled view of a male sexual stimulation device according to a fifth embodiment of the present application.

FIG. 30 shows the male sexual stimulation device of FIG. 29 from another aspect, wherein a portion of a shell being removed.

FIG. 31 is an enlarged view of a circle XXVII of FIG. 30.

FIG. 32 is a schematic, assembled view of a second stimulation module of the male sexual stimulation device of FIG. 29.

FIG. 33 is an exploded view of the second stimulation module of FIG. 33.

FIG. 34 is a schematic, assembled view of a male sexual stimulation device according to a sixth embodiment of the present application.

FIG. 35 is a schematic, assembled view of a stimulation assembly of the male sexual stimulation device of FIG. 34.

FIG. 36 is an exploded view of the stimulation assembly of FIG. 35.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

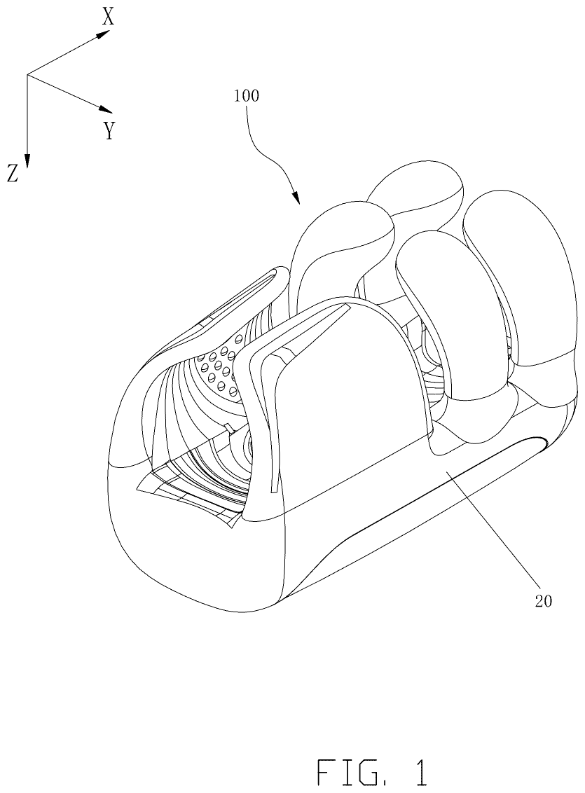

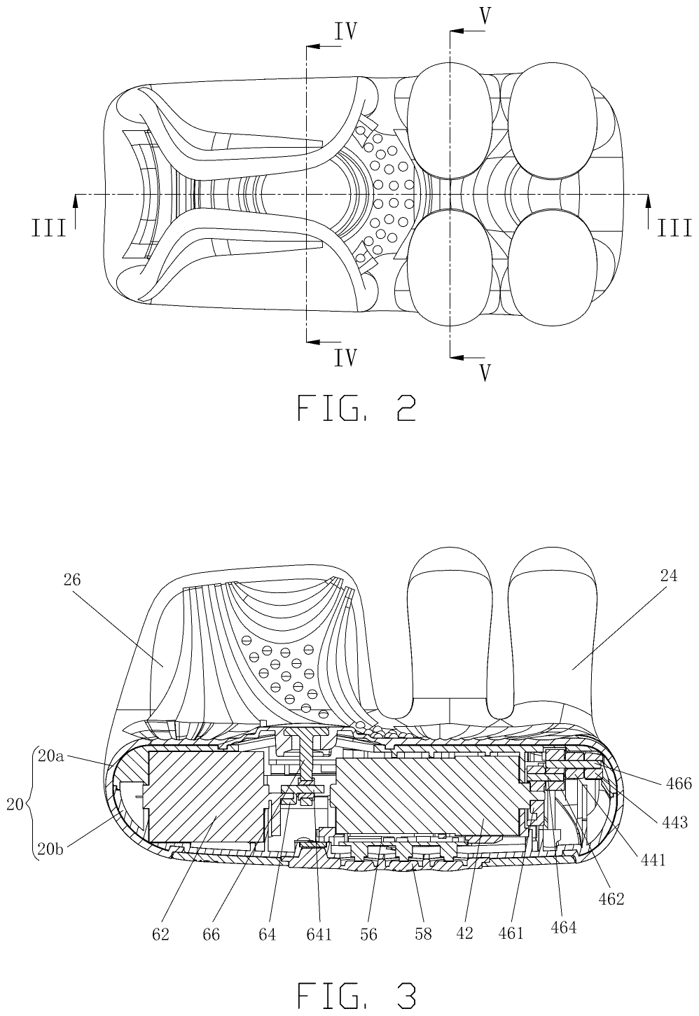

Referring to FIG. 1 to FIG. 6, a male sexual stimulation device 100 according an embodiment of the present application is shown. The male sexual stimulation device 100 includes a shell 20 and a stimulation assembly mounted in the shell 20.

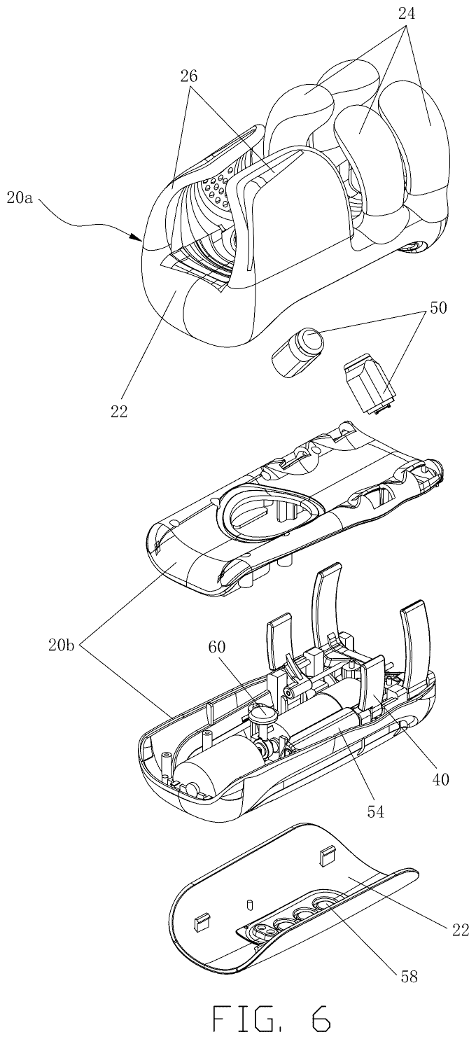

As shown in FIG. 1 and FIG. 6, the shell 20 in whole is configured as a human hand, which includes a main portion 22 configured as a palm and several swinging portion 24 extending from two opposite sides of the main portion 22, respectively. The swinging portions 24 each are elongated, curved, and column-shaped, being configured as a finger. Further, two fixed portions 26 extend from two opposite sides of the main portion 22, respectively. The fixed portions 26 each are configured as a curved sheet, and arranged in a row with the swinging portions 24 at a same lateral side of the main portion 22.

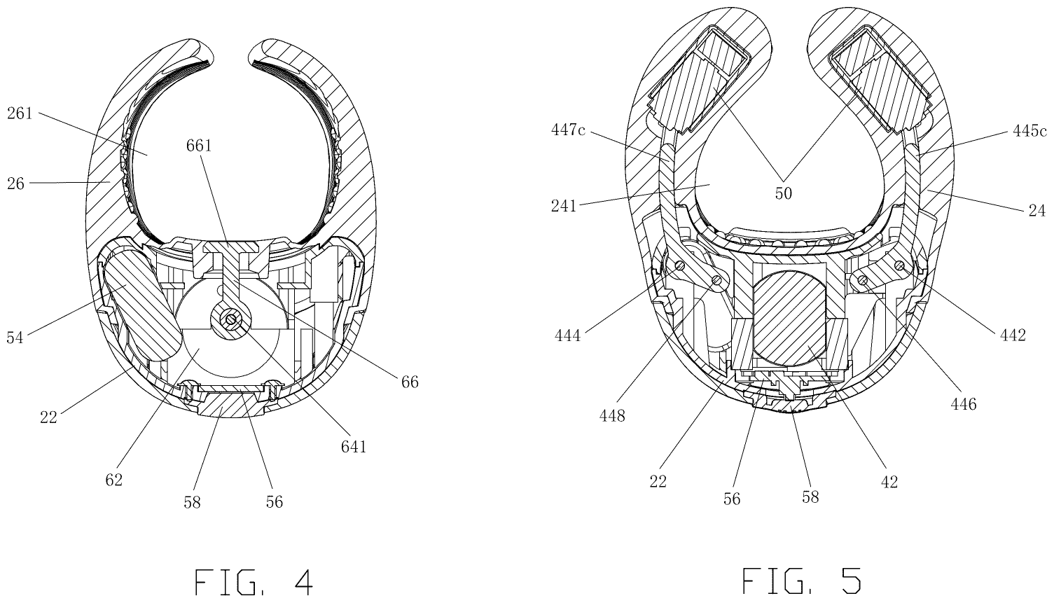

Referring also to FIG. 5, the swinging portions 24 of the shell 20 cooperatively define a first inner chamber 241 thereamong. Referring also to FIG. 4, the fixed portions 26 of the shell 20 cooperatively define a second inner chamber 261 therebetween. The first inner chamber 241 and second inner chamber 261 communicate with each other and cooperatively define an accommodating space, which is generally column-shaped and configured for receiving a sensitive part of the human body, such as a male genitalia therein.

As shown in FIG. 3 to FIG. 6, the shell 20 is a double-layer structure, and includes an outer shell 20a and an inner shell 20b inside the outer shell 20a. The inner shell 20b may be made of hard materials, such as plastic, metal and etc., providing support to the stimulation assembly mounted inside the shell 20; and the outer shell 20a may be made of soft materials, such as silicone, rubber and etc., for directly contacting the male genitalia, thereby the male sexual stimulation device 100 in whole has high strength and comfortable use experience.

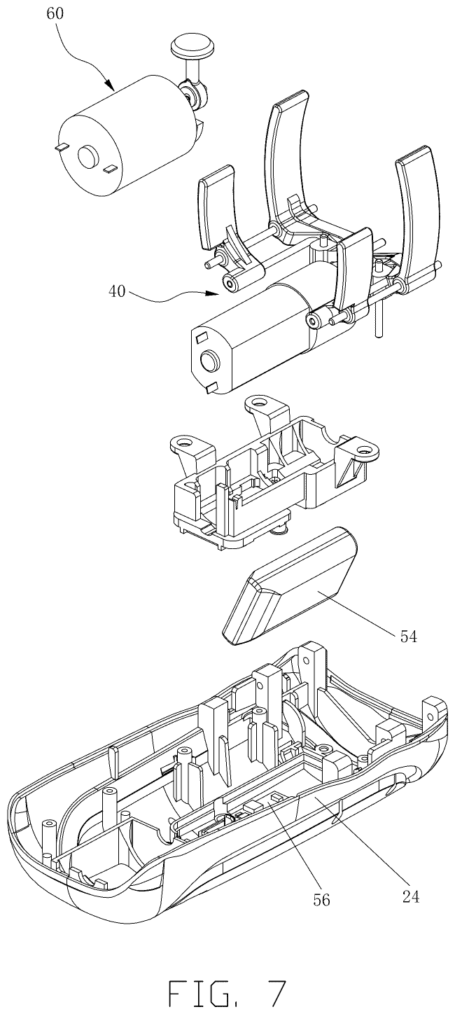

Referring to FIG. 6 and FIG. 7, the stimulation assembly of this embodiment includes a first stimulation module 40 and a second stimulation module 60.

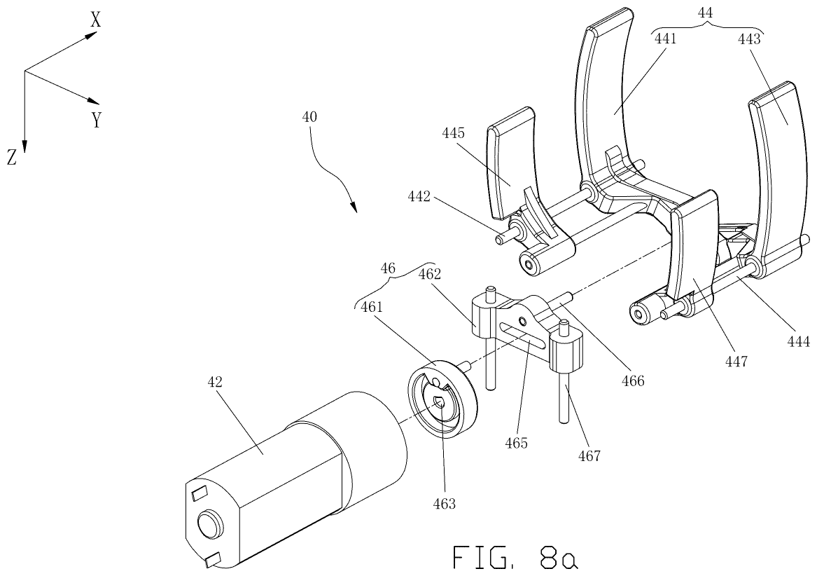

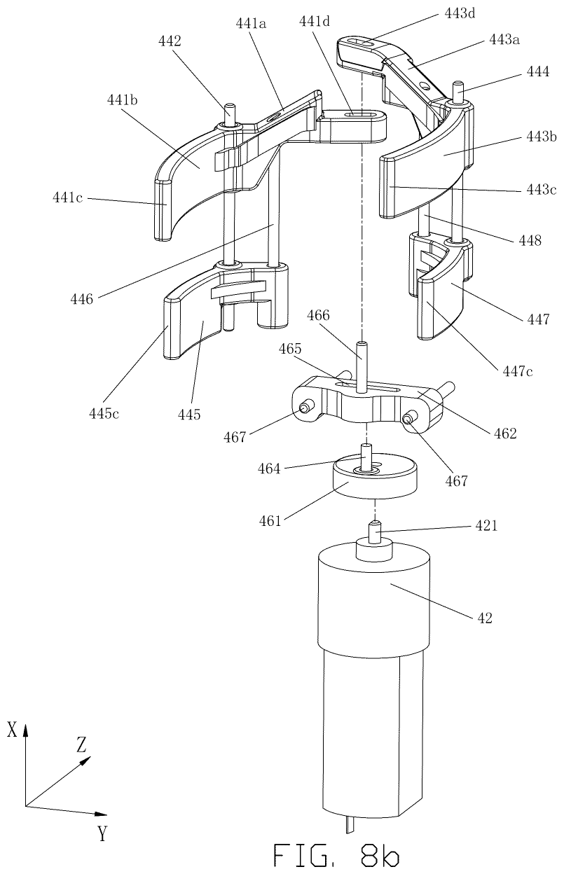

As shown in FIGS. 8a and 8b, the first stimulation module 40 includes a first motor 42, a swinging unit 44 and a transmission unit 46 connected between the first motor 42 and the swinging unit 44. The swinging unit 44 includes a first swinging bar 441 and a second swinging bar 443 which are substantially arranged symmetric to each other. During operation of the first motor 42, the first swinging bar 441 and second swinging bar 443 are driven to swing relative to the shell 20, close to or away from each other, thereby achieving an occlusion action to occlude the male genitalia inside the accommodating space.

The first swinging bar 441 includes a first connecting arm 441a and a first swinging arm 441b which are connected to each other. Preferably, the first connecting arm 441a and the first swinging arm 441b are integrally formed as one piece, and an included angle is set therebetween. A joint portion of the first connecting arm 441a and the first swinging arm 441b is rotatably connected to the inner shell 20b by a first pivot 442. A distal end of the first connecting arm 441a away from the first swinging arm 441b is connected to the transmission unit 46, and a distal end of the first swinging arm 441b away from the first connecting arm 441a is configured as a first swinging end 441c and extends into one of the swinging portions 24 at a first lateral side (such as a left side in FIG. 8a) of the shell 20.

Similarly, the second swinging bar 443 includes a second connecting arm 443a and a second swinging arm 443b which are connected to each other and angled with each other. A joint portion of the second connecting arm 443a and the second swinging arm 443b is rotatably connected to the inner shell 20b by a second pivot 444. A distal end of the second connecting arm 443a away from the second swinging arm 443b is connected to the transmission unit 46, and a distal end of the second swinging arm 443b away from the second connecting arm 443a is configured as a second swinging end 443c and extends into one of the swinging portions 24 at a second lateral side (such as a right side in FIG. 8a) of the shell 20.

The distal ends of the first and second connecting arms 441a, 443a can be driven to move along a first direction, such as Z-direction, and thus the first and second swinging arms 441b, 443b can swing about the first pivot 442 and second pivot 444, respectively.

The first pivot 442 and second pivot 444 both extend along a second direction, such as X-direction, being parallel to and spaced from each other. The first swinging end 441c and the second swinging end 443c are opposite to each other in a third direction, such as Y-direction. During operation, the first motor 42 drives the distal ends of the first connecting arm 441a and the second connecting arm 443a to do reciprocating movement synchronously in the Z-direction through the transmission unit 46, making the first swinging bar 441 swing about the first pivot 442 and the second swinging bar 443 swing about the second pivot 444 in opposite directions, thereby the first swinging end 441c and second swinging end 443c swinging towards or away from each other to achieve the occlusion action.

In this embodiment, the swinging unit 44 further includes a third swinging bar 445 and a fourth swinging bar 447 which are arranged substantially symmetric to each other. The first pivot 442 extends through a middle portion of the third swinging bar 445 to rotatably connect the third swinging bar 445 to the inner shell 20b, and the second pivot 444 extends through a middle portion of the fourth swinging bar 447 to rotatably connect the fourth swinging bar 447 to the inner shell 20b. The first pivot 442 may be fixed to the first and third swinging bars 441, 445 to rotate along therewith, or, may be fixed to the inner shell 20b; and the second pivot 444 may be fixed to the second and fourth swinging bars 443, 447 to rotate along therewith, or, may be fixed to the inner shell 20b.

The third swinging bar 445 has one end configured as a third swinging end 445c and extends into another one of the swinging portions 24 at the first lateral side of the shell 20, and another end being fixedly connected to the first connecting arm 441a of the first swinging bar 441 by a third pivot 446, thereby the third swinging bar 445 can swing about the first pivot 442 together with the first swinging bar 441; and the fourth swinging bar 447 has one end configured as a fourth swinging end 447c and extends into another one of the swinging portions 24 at the second lateral side of the shell 20, and another end being fixedly connected to the second connecting arm 443a of the second swinging bar 443 by a fourth pivot 448, thereby the fourth swinging bar 447 can swing about the second pivot 444 together with the second swinging bar 443. The third swinging end 445c and the fourth swinging end 447c are opposite to each other in the Y-direction, which can swing towards or away from each other to achieve an occlusion action.

In this embodiment, corresponding to the first to fourth swinging ends 441c, 442c, 445c, 447c of the first to fourth swinging bars 441, 443, 445, 447 of the swinging unit 44 of the first stimulation module 40, the shell 20, specifically the outer shell 20a, is provided with four swinging portions 24 which accommodate the four swinging ends 441c, 442c, 445c, 447c therein, respectively. During operation, the swinging portions 24 swing together with the swinging ends 441c, 442c, 445c, 447c to occlude the male genitalia in the accommodating space. Such male sexual stimulation device can simulate a human hand to hold and pinch the male genitalia, which can better stimulate users.

It should be understood that a number of the swinging bars of the swinging unit is preferably multiple, such as two, three, four, six, eight, etc., which should not be limited to specific embodiments; and, a number of the swinging portions of the shell may be designed the same as that of the swinging bars, thereby accommodating and swinging together with the swinging ends of the swinging bars, respectively.

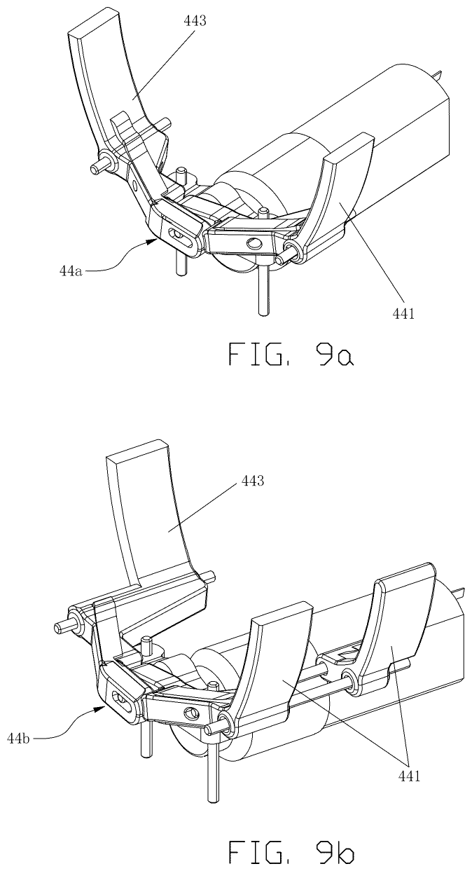

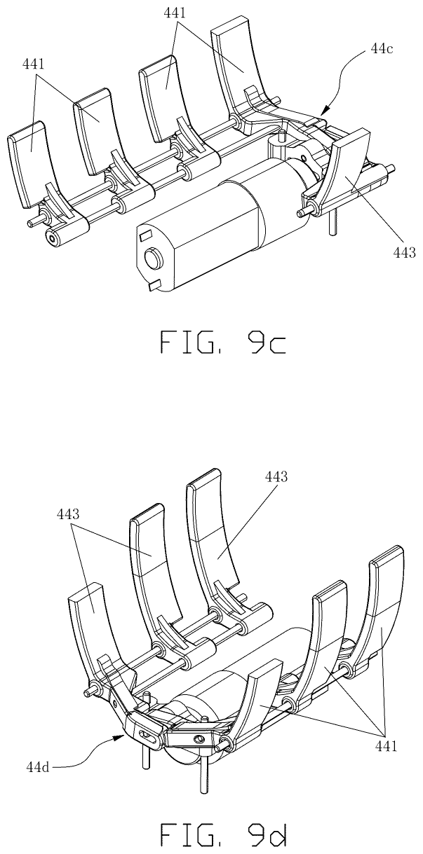

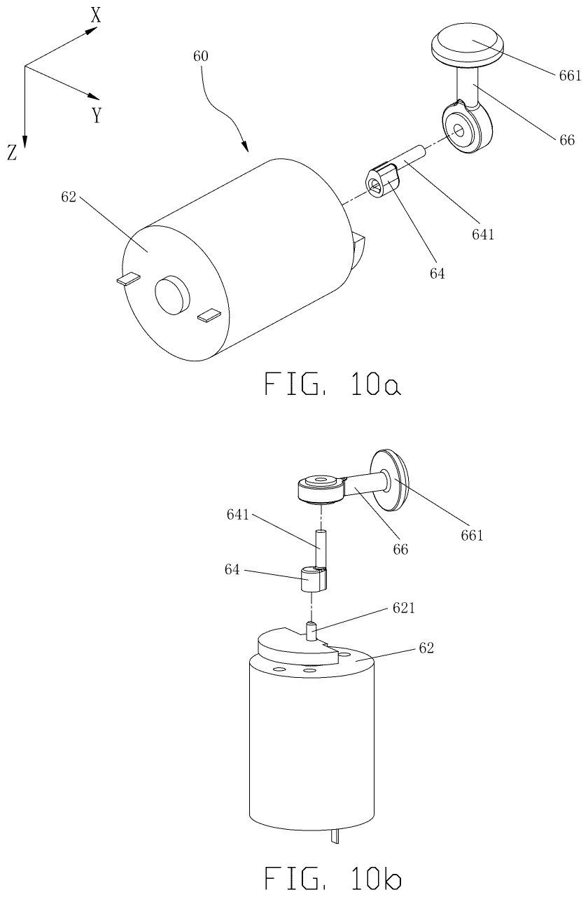

FIG. 9a to FIG. 9d show alternative embodiments of the swinging unit. FIG. 9a shows a swinging unit 44a with a first swinging bar 441 and a second swinging bar 443, wherein the two swinging bars 441, 443 are arranged substantially symmetric to each other in the Y-direction. FIG. 9b shows a swinging unit 44b with three swinging bars 441, 443 being staggered in the X-direction, wherein two first swinging bars 441 are located at the same lateral side, and one second swinging bar 443 is located at an opposite lateral side. FIG. 9c shows a swinging unit 44c with five swinging bars 441, 443, wherein four first swinging bars 441 are located at the same lateral side, and one second swinging bas 443 is located at an opposite lateral side. FIG. 9d shows a swinging unit 44d with six swinging bars 441, 443, wherein one lateral side is provided with three first swinging bars 441 and an opposite lateral side is provided with three second swinging bars 443.

Referring to FIG. 8a and FIG. 8b, in this embodiment, the first motor 42 is a rotary motor, and has a rotary shaft 421 for outputting torque. The transmission unit 46 is configured for converting rotation of the first motor 42 into reciprocating movement along the first direction, thereby driving the distal ends of the first and second connecting arms 441a, 443a to move in the first direction. The transmission unit 46 includes a first eccentric wheel 461 and a sliding block 462.

The first eccentric wheel 461 is connected to the rotary shaft 421 of the first motor 42. In this embodiment, the first eccentric wheel 461 is generally circular-shaped, and a central hole 463 is defined in a central portion thereof for inserting of the rotary shaft 421 therein. The central hole 463 of the first eccentric wheel 461 is non-circular shaped, such as D-shaped, and a cross section of the rotary shaft 421 has a shape matching with that of the central hole 463. After inserting of the rotary shaft 421 into the central hole 463 of the first eccentric wheel 461, a relative rotation therebetween is limited for shape matching, thereby the first eccentric wheel 461 can rotate along with the rotary shaft 421 of the first motor 42.

A first rod 464 extends outwardly from a periphery of the first eccentric wheel 461, that is, the first rod 464 is set eccentrically on the first eccentric wheel 461. Generally, the first rod 464 is parallel to the rotary shaft 421 of the first motor 42. During rotation of the first eccentric wheel 461 along with the rotary shaft 421 of the first motor 42, the first rod 464 revolves round the rotary shaft 421. In this embodiment, the rotary shaft 421 extends along the X-direction, and the first rod 464 revolves round the rotary shaft 421 in YZ plane. In other words, the first rod 464 generates displacements on both the Y-direction and the Z-direction under the driving of the first motor 42.

The sliding block 462 defines a sliding groove 465 therein, which is strip-shaped and elongated in the Y-direction. The first rod 464 engages into the sliding groove 465, and is fixed relative to the sliding block 462 in the Z-direction whilst is slidable relative to the sliding block 462 in the Y-direction. During revolving of the first rod 464 round the rotary shaft 421, its displacement in the Y-direction cannot drive the sliding block 462 to move, while its displacement in the Z-direction drives the sliding block 462 to do reciprocating movement. Thereby, rotation of the first motor 42 is converted into reciprocating liner motion of the sliding block 462 in the Z-direction.

In this embodiment, the distal end of the first connecting arm 441a defines a first slot 441d therein, and the distal end of the second connecting arm 443a defines a second slot 443d therein. A second rod 466 extends outwardly from the sliding block 462 along the X-direction, and is movably engaged into the first slot 441d and the second slot 443d, thereby the sliding block 462 can drive the distal ends of the first and second connecting arms 441a, 443a to do reciprocating movement synchronously in the Z-direction. The first and second slots 441d, 443d may be strip-shaped in an extension direction of the first and second connecting arms 441a, 443a, thereby the second rod 466 having more movement allowance in the first and second slots 441d, 443d.

In this embodiment, the sliding block 462 is movably connected to the inner shell 20b by a fifth pivot 467 which extends along the Z-direction. The fifth pivot 467 movably extends through the sliding block 462, thereby guiding movement of the sliding block 462 in the Z-direction. Preferably, each end of the sliding block 462 in the Y-direction is provided with one fifth pivot 467, thus a movement of the sliding block 462 in the Z-direction can be more stable, and accordingly swinging of the swinging ends 441c, 442c, 445c, 447c of the swinging unit 44 driven by the second rod 466 of the sliding block 462 can be more consistent and powerful. That is to say, the stimulation intensity of each swinging portion 24 of the male sexual stimulation device 100 is more consistent and the overall stimulation effect is better.

As shown in FIG. 5 and FIG. 6, the stimulation assembly further includes at least one second motor 50, such as a vibration motor. The second motor 50 is set in the swinging portions 24 of the shell 20, and located adjacent to distal ends of the swinging portions 24. The second motor 50 is configured for generating high-frequency vibration to the male genitalia in the accommodating space. Preferably, there are several second motors 50, and each second motor 50 is set in one of the swinging portions 24. During in use, the first stimulation module 40 or the vibration motor 50 may be started separately, or the first stimulation module 40 and vibration motor 50 may be started at the same time.

As shown in FIG. 10a and FIG. 10b, the second stimulation module 60 includes a third motor 62 with an rotary shaft 621, a third eccentric wheel 64 connected to the rotary shaft 621 of the third motor 62, and a swinging rod 66 connected to the third eccentric wheel 64. The third eccentric wheel 64 has a third rod 641 extending out therefrom, and the third rod 641 is parallel to the rotary shaft 621 of the third motor 62. The swinging rod 66 is generally perpendicular to the third rod 641, with one end thereof being rotatably mounted around the third rod 641 and another end thereof embedded into the main portion 22 of the shell 20, specifically a part of the main portion 22 corresponding to second inner chamber 261 between the fixed portions 26.

Preferably, a head 661 with a diameter larger than other portions of the swinging rod 66 is formed at the another end of the swinging rod 66, improving a stability of the connection between the swinging rod 66 and the main portion 22. Preferably, for facilitating the movement of the swinging rod 66, the part of the main portion 22 corresponding to the head 661 of the swinging rod 66 is configured only with the soft outer shell 20a, i.e., without the hard inner shell 20b, as shown in FIG. 3 and FIG. 4.

Referring also to FIG. 3 and FIG. 4, the rotary shaft 621 of the third motor 62 and the third rod 641 of the third eccentric wheel 64 both extend along the X-direction, and the swinging rod 66 extends along the Z-direction. During operation, rotation of the third motor 62 is converted into revolving of the swinging rod 66 about the rotary shaft 621, and then converted into reciprocating movement of the swinging rod 66 and the part of the main portion 22 adjacent to the head 661 of the swinging rod 66 in the Z-direction since the swinging rod 66 is limited to move in the X-direction and Y-direction for the engagement with the shell 20. At the same time, a relative rotation is generated between the swinging rod 66 and the third rod 641. That is, the second stimulation module 60 provides reciprocating motion in the Z-direction to drum the male genitalia in the accommodating space.

The first and second stimulation modules 40, 60 provide stimulation to different parts of the male genitalia in different manners and thus can achieve better stimulation effects. It should be understood that the second stimulation module 60 may be started separately, or may be used with the first stimulation module 40 at the same time. For enhance user comfort, the swinging portions 24 of the shell 20, which forms the first inner chamber 241, the fixed portions, which forms the second inner chamber 261, are configured only with the soft outer shell 20a, i.e., without the hard inner shell 20b.

Referring to FIG. 6 and FIG. 7 again, a battery 54, preferably a rechargeable battery, is arranged in the main portion 22 of the shell 20 for supplying electric power to electric components, such as the first, second and third motors 42, 50, 62, of the male sexual stimulation device 100. Further, a control circuit board 56 is mounted in the shell 20 and electrically connected to the first, second and third motors 42, 50, 62 for controlling their operation according to user's instructions, such as controlling the vibration frequency of the second motor 50, controlling the rotary speed of the first and third motors 42, 62, and etc. Control buttons 58, such as mechanical buttons or touch buttons, may be provided on the outer shell 20a for input the user's instructions.

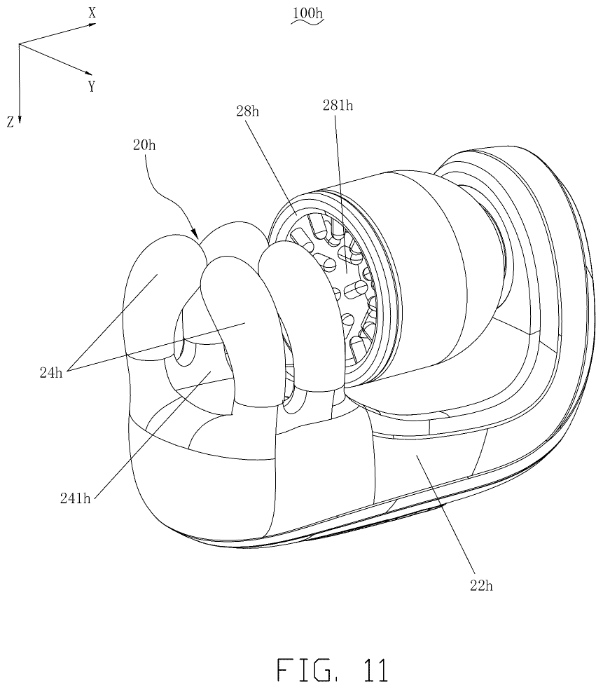

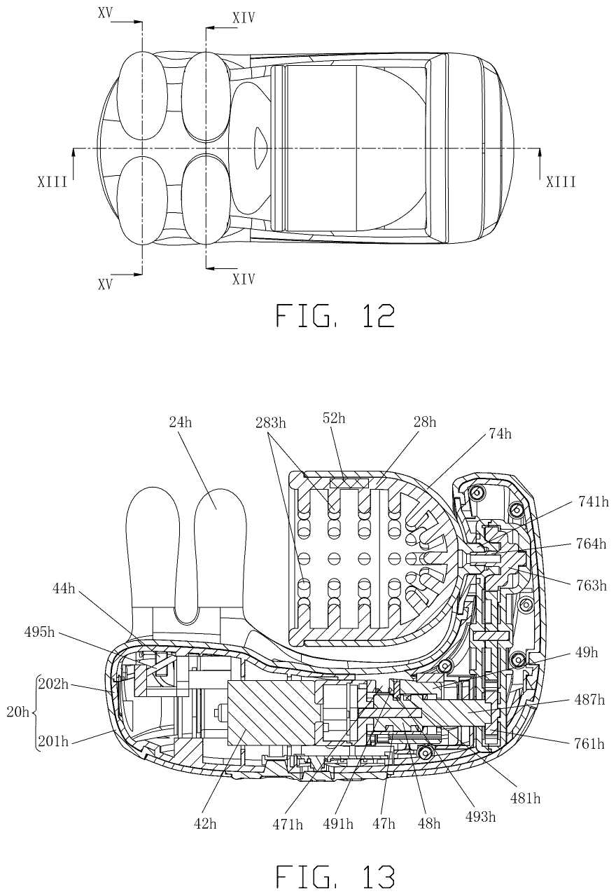

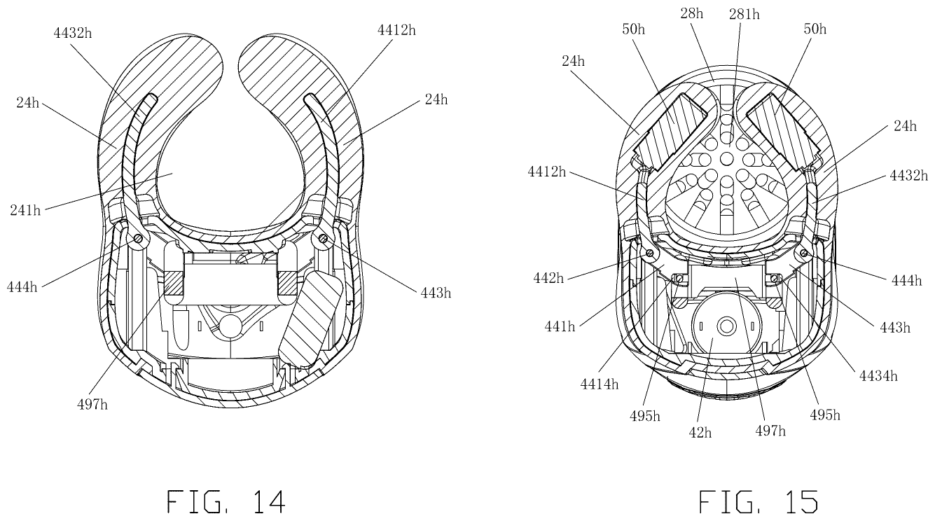

Referring to FIG. 11 to FIG. 17, a male sexual stimulation device 100h according to a second embodiment of the present application is shown. The male sexual stimulation device 100h includes a shell 20h and a stimulation assembly mounted in the shell 20h.

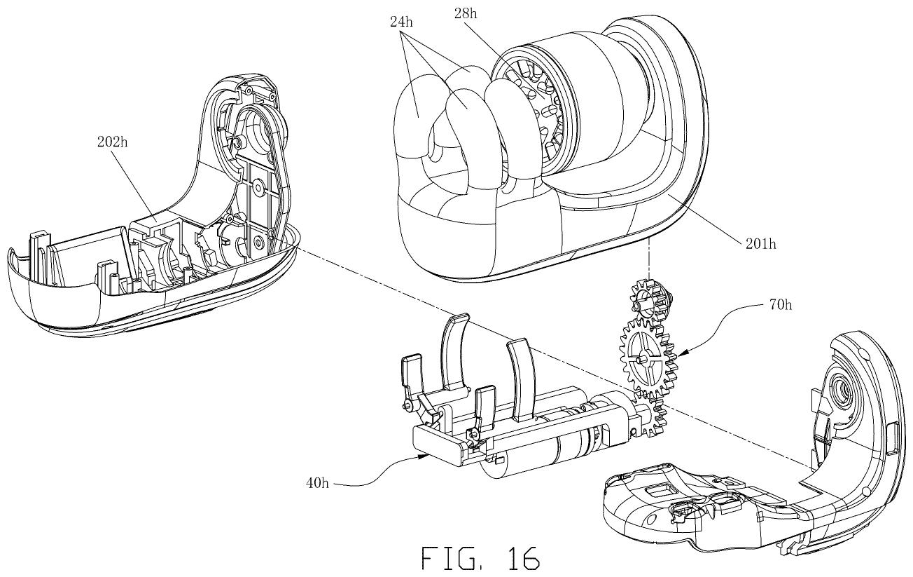

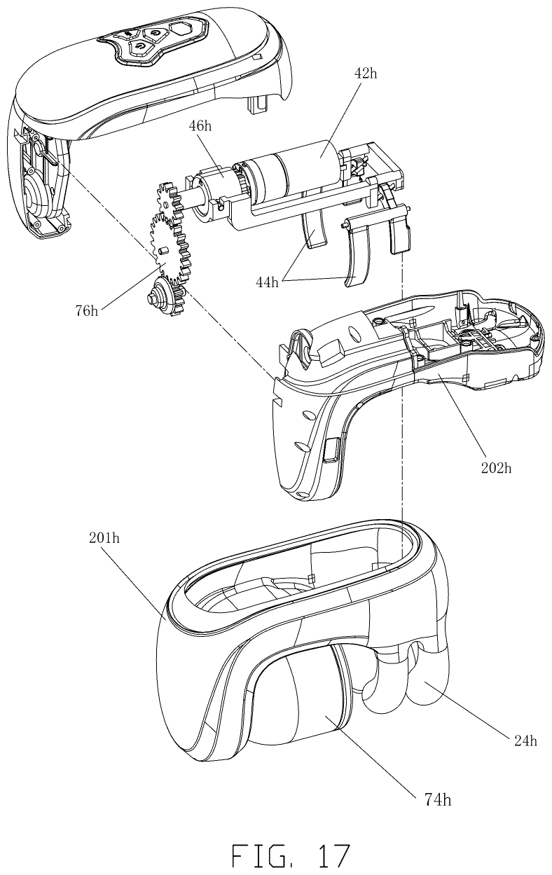

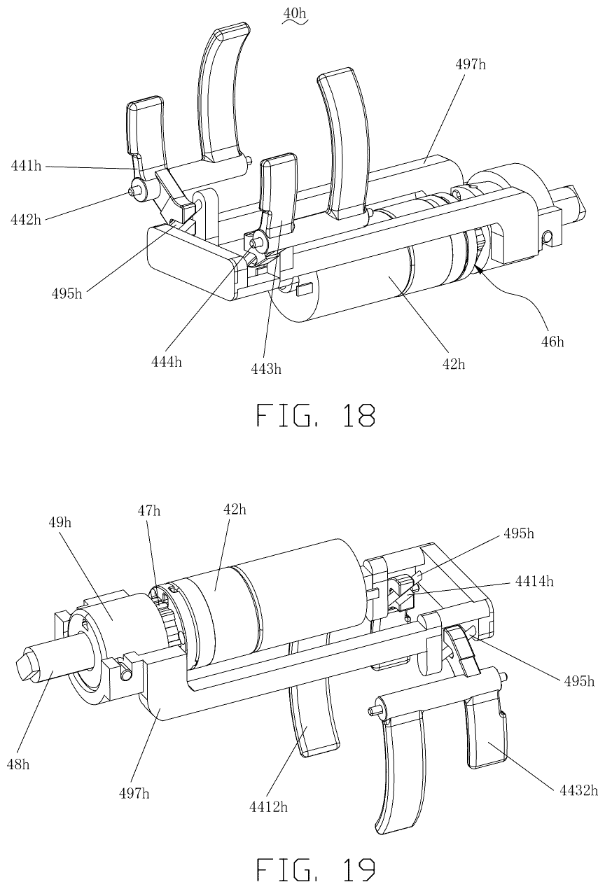

The shell 20h includes a main portion 22h, a plurality of swinging portions 24h, and a rotary portion 28h. As shown in FIG. 13 and FIG. 16, the shell 20h is configured as a double-layer structure, includes a flexible outer shell 201h and a hard inner shell 202h inside the outer shell 201h, wherein the swinging portions 24h and rotary portion 28h are configured as a single-layer structure, preferably constructed as a part of the flexible outer shell 201h, thereby having a soft touch and a certain elastic buffering effect, making the user feel more comfortable.

Similar to the first embodiment, the swinging portions 24h are configured as elongated and curved columns, extending from two opposite sides of the main portion 22h, respectively. Cooperatively, the swinging portions 24h define a first inner chamber 241h.

In this embodiment, the rotary portion 28h is generally cylindrical-shaped, and arranged at an axial end of and spaced from the swinging portions 24h. An inner end of the rotary portion 28h close to the swinging portions 24h is open, and an outer end of the rotary portion 28h away from the swinging portions 24h is closed. A second inner chamber 281h is defined in the rotary portion 28h, and communicates with the first inner chamber 241h through the open inner end of the rotary portion 28h. The first inner chamber 241h and the second inner chamber 281h cooperatively form an accommodating space for receiving the male genitalia therein.

During use, the male genitalia extends through the first inner chamber 241h between the swinging portions 24h into the second inner chamber 281h inside the rotary portion 28h, with a glans penis being enveloped by the closed end of the rotary portion 28h, which is more comfortable.

Referring to FIG. 16 and FIG. 17, the stimulation assembly includes a first stimulation module 40h configured for driving the swinging portions 24h to swing, so as to pinch a rear end of the male genitalia, and a second stimulation module 70h configured for driving the rotary portion 28h to rotate, so as to rub against a front end of the male genitalia. Thus, the swinging portions 24h function as a first stimulation part and the rotary portion 28h function as a second stimulation part, acting on the male genitalia in different ways, thereby providing a better sexual experience.

As shown in FIGS. 18-20, the first stimulation module 40h includes a first motor 42h, a swinging unit 44h and a first transmission unit 46h connected between the first motor 42h and the swinging unit 44h.

The swinging unit 44h includes a first swinging bar 441h and a second swinging bar 443h which are substantially arranged symmetric to each other. The first swinging bar 441h is rotatably mounted in the shell 20h by a first pivot 442h, and the second swinging bar 443h is rotatably mounted in the shell 20h by a second pivot 444h. Each of the first and second swinging bars 441h, 443h includes a swinging arm with a distal end being configured as a swinging end 4412h, 4432h and engaged into the swinging portions 24h and a connecting arm with a distal end defining a slot 4414h, 4434h for connecting the swinging unit 44h to the first transmission unit 46h.

The first transmission unit 46h includes a fixed member 47h, a rotary member 48h, and a sliding member 49h that cooperate with each other, converting rotation of the first motor 42h into reciprocating linear movement of the sliding member 49h.

The fixed member 47h is fixedly installed in the shell 20h, for example, fixedly connected to a motor housing of the first motor 42h by screws and the like. The fixed member 47h is provided with a first sliding groove 471h which extends along the X-direction.

The rotary member 48h is connected to a rotary shaft 421h of the first motor 42h, and rotates about an axis extending in the X-direction under the action of the first motor 42h. The rotary member 48h and the rotary shaft 421h may be fixed in the circumferential direction through shape fitting and the like, so as to rotate synchronously. The rotary member 48h is provided with a second sliding groove 481h, which extends spirally in a circumferential direction of the rotary member 48h.

The sliding member 49h includes a first sliding block 491h and a second sliding block 492h, wherein the first sliding block 491h is slidably engaged into the first sliding groove 471h of the fixed member 47h and the second sliding block 492h is slidably engaged in the second sliding groove 481h of the rotary member 48h. Through the cooperation of the first sliding block 491h and first sliding groove 471h and the cooperation of the second sliding block 492h and second sliding groove 481h, rotation of the first motor 42h is converted into the reciprocating movement of the sliding member 49h in the X-direction.

In the illustrated embodiment, the rotary member 48h is designed as a rotating shaft and is fixedly coupled onto the rotary shaft 421h of the first motor 42h. The fixed member 47h is cylindrical-shaped and mounted around the rotary member 48h. The sliding member 49h is cylindrical-shaped and mounted around the fixed member 47h. The first sliding block 491h protrudes inwardly from the sliding member 49h into the first sliding groove 471h of the fixed member 47h, and the second sliding block 492h extends through the first sliding groove 471h into the second sliding groove 481h of the rotary member 48h.

The second sliding block 492h is preferably an arc-shaped sheet that can adapt to the shape of a groove wall of the second sliding groove 481h. In this embodiment, the second sliding block 492h is formed separately and then fixedly connected to the first sliding block 491h, facilitating assembly of the sliding member 49h to the rotary member 48h. In some embodiments, the second sliding block 492h and the first sliding block 491h may be integrally formed as one piece.

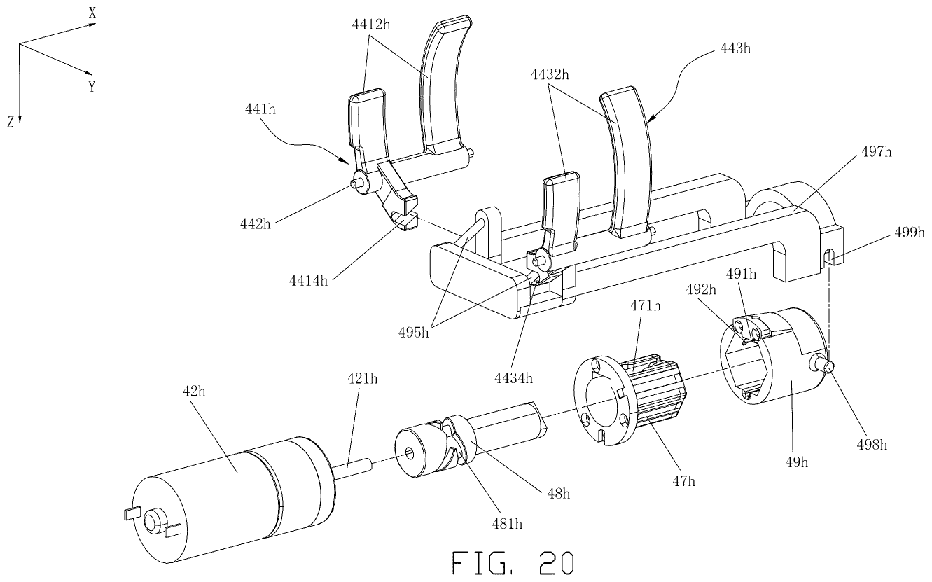

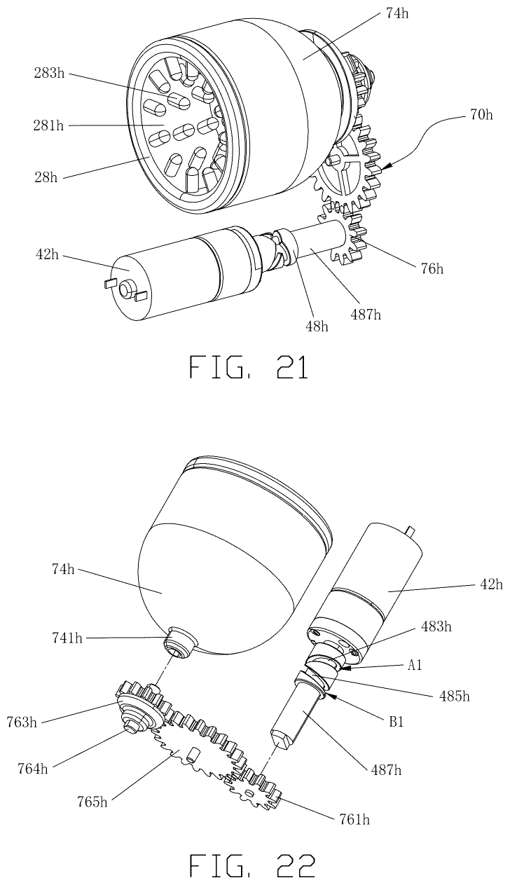

Referring to FIG. 20 and FIG. 22, the second sliding groove 481h includes a first spiral segments 483h and a second spiral segment 485h which are arranged symmetrically. The first spiral segment 483h extends clockwise from a first proximal end A1 to a first distal end B1, and the second spiral segment 485h extends counterclockwise from the first proximal end A1 to the first distal end B1. The first proximal end A1 and the first distal end B1 are spaced apart by a certain distance in the axial direction of the rotary member 48h.

During sliding of the second sliding block 492h along the second sliding groove 481h from the first proximal end A1 to the first distal end B1, the sliding member 49h moves away from the fixed member 47h along the X-direction. During sliding of the second sliding block 492h along the second sliding groove 481h from the first distal end B1 to the first proximal end A1, the sliding member 49h moves towards the fixed member 47h along the X-direction. Thus, rotation of the rotary member 48h causes the sliding member 49h to do reciprocating liner motion in the X-direction.

In the illustrated embodiment, the first proximal end A1 and the first distal end B1 of the second sliding groove 481h are located on a same generatrix of the rotary member 48h, and a span of the first spiral segment 483h or the second spiral segment 485h is an entire circle in the circumferential direction. In some embodiments, the first proximal end A1 and the first distal end B1 may be located on opposite sides of the rotary member 48h, i.e., half a circle apart in the circumferential direction. In this case, the span of the first spiral segment 483h or the second spiral segment 485h in the circumferential direction may be half a circle.

In some embodiments, the second sliding groove 481h may be formed on the rotary shaft 421h of the first motor 42h. In this case, the rotary member 48h may be omitted, or a part of the rotary shaft 421h with the second sliding groove 481h may be regarded as the rotary member 48h.

The fixed member 47h, rotary member 48h, and sliding member 49h cooperate with each other to form the first transmission unit 46h, which converts the rotation of the first motor 42h into the reciprocating liner motion of the sliding member 49h.

In this embodiment, the sliding member 49h is provided with two transmission rods 495h, wherein each transmission rod 495h is engaged into the slot 446h of one of the first and second swinging bars 441h, 443h. The transmission rod 495h is inclined to the X-direction in which the first and second pivots 442h, 444h extend and the sliding member 49h moves. Due to the inclined arrangement of the transmission rod 495h, the movement of the transmission rod 495h along with the sliding member 49h in the X-direction causes the distal end of the connecting arm of the swinging bar 441h, 443h to be lifted or pressed down.

As a result, the swinging ends 445h of the first and second swinging bars 441h, 443h are driven to swing towards or away from each other with their corresponding pivots 442h, 444h as the rotary center, which in turn drives the swinging portions 24h to swing towards or away from each other. In this embodiment, the slot 4414h in the distal end of the connecting arm of the swinging bar 441h, 442h is generally U-shaped, facilitating moving and rotating of the transmission rod 495h in the slot 4414h.

In this embodiment, a sliding frame 497h is set on the first motor 42h and the first transmission unit 46h, and connected to the sliding member 49h of the first transmission unit 46h. Specifically, the sliding member 49h is provided with two connecting rods 498h at two opposite sides thereof, respectively, and the sliding frame 497h is provided with two apertures 499h. Each connecting rod 498h engages into one corresponding aperture 499h to fix the sliding frame 497h to the sliding member 49h in the X-direction. The two transmission rods 495h are provided on the sliding frame 497h, located at an end of the sliding frame 497h away from the apertures 499h, facilitating the connection of the swinging unit 46h.

In other embodiments, the connecting rod may be formed on the sliding frame 497h, and the aperture may be defined in the sliding frame 497h. In other embodiments, the sliding frame 497h and the sliding frame 497h may be fixed together in the X-direction by screws, snap-fitting, bonding, and etc. In other embodiments, the transmission rod 495h may be directly formed on the sliding member 49h, thereby omitting the sliding frame 497h.

In this embodiment, as shown in FIG. 15, a second motor 50h, such as a vibration motor is provided in the swinging portions 24h, so that the swinging portions 24h can vibrate at high frequency during swinging, further enhancing its stimulation effect to the male genitalia.

As shown in FIGS. 21-22, the second stimulation module 70h includes a driving motor, a rotary shell 74h mounted around the rotary portion 28h, and a second transmission unit 76h connected between the rotary shell 74h and the driving motor. In this embodiment, the first motor 42h further serves as the driving motor of the second stimulation module 70h. That is, the swinging portions 24h and the rotary portion 28h are driven by the same component, i.e., the first motor 42h.

The rotary shell 74h is made of hard materials, such as plastic, metal, and etc. A hardness of the rotary shell 74h is higher than that of the rotary portion 28h, so as to support the rotary portion 28h and transfer the torque of the first motor 42h to the rotary portion 28h more effectively. Preferably, the rotary portion 28h is integrally formed inside the rotary shell 74h by over-molding, so that the rotary shell 74h and the rotary portion 28h can be driven to rotate synchronously.

The second transmission unit 76h may be a gear transmission unit, which includes multiple gears that mesh with each other. One of the gears serves as an input wheel 761h and is connected to a rotary shaft 421h of the first motor 42h. Another gear serves as an output wheel 763h and is connected to the rotary shell 74h. The input wheel 761h and the output wheel 763h may be meshed with each other directly, or one or more intermediate gears 756h may be provided between the input wheel 761h and the output wheel 763h.

In this embodiment, a shaft seat 741h extends outwards from the rotary shell 74h, and a central shaft 764h of the output wheel 763h of the second transmission unit 76h is inserted into the shaft seat 741h to drive the rotary shell 74h and the rotary portion 28h to rotate.

Through the second transmission unit 76h, not only power can be transmitted over a long distance between the first motor 42h and the rotary portion 28h, but a direction of power transmission may also be changed, facilitating the arrangement of the first motor 42h. In other embodiments, the second transmission unit 76h may be a pulley transmission unit, a worm gear transmission unit, or a combination of multiple transmission units, as long as it can drive the rotary portion 28h to rotate.

In this embodiment, the input wheel 761h of the second transmission unit 76h is connected to a transmission rod 487h extending from the rotary member 48h. That is, the input wheel 761h is connected to the first motor 42h through the rotary member 48h. In some embodiments, the input wheel 761h may be directly connected to the rotary shaft 421h of the first motor 42h. In addition, the rotary shell 74h may be connected to the rotary member 48h or the rotary shaft 421h of the first motor 42h directly, omitting the second transmission unit 76h.

In some embodiments, referring to FIG. 13, a vibration motor 52h may be embedded in the rotary portion 28h, so that the rotary portion 28h can vibrate at high frequency during rotation, further enhancing its stimulation effect to the male genitalia.

As shown in FIG. 13, in this embodiment, the shell 20h in whole is generally L-shaped. The swinging portions 24h is provided on an upper side of a transverse part of the shell 20h, and the rotary portion 28h is provided on an inner side of a longitudinal part of the shell 20h. Preferably, an inner wall of the rotary portion 28h, which surrounds the second inner chamber 281h, is provided with a plurality of protrusions 283h, such as convex points, convex bulges, convex columns, convex strips, and etc., for enhancing the stimulation effect on the male genitalia. It should be understood that inner walls of the swinging portions 24 surrounding the first inner chamber 241h may also be provided with protrusions.

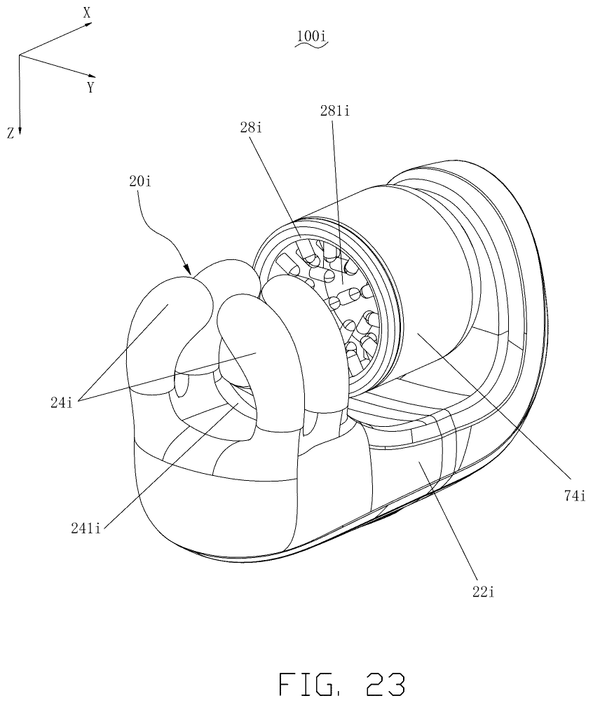

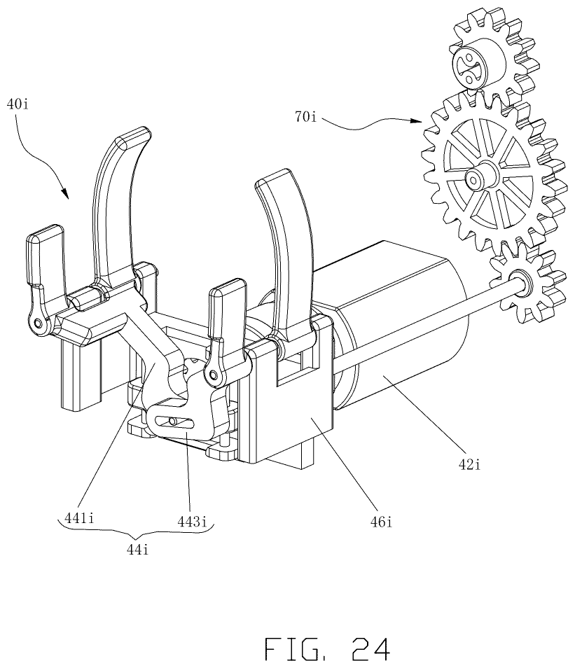

Referring to FIGS. 23-25, a male sexual stimulation device 100i according to a third embodiment of the present application is shown. The male sexual stimulation device 100i includes a shell 20i and a stimulation assembly mounted in the shell 20i.

Similar to the second embodiment, the shell 20i includes a main portion 22i, a plurality of swinging portions 24i extending from two opposite sides of the main portion 22i, respectively, and a rotary portion 28i provided at an axial end of and spaced from the swinging portions 24i. Cooperatively, the swinging portions 24i define a first inner chamber 241i. A second inner chamber 281i is defined in the rotary portion 28i and communicates with the first inner chamber 241i. The first inner chamber 241i and the second inner chamber 281i cooperatively form an accommodating space for receiving the male genitalia therein.

The stimulation assembly includes a first stimulation module 40i configured for driving the swinging portions 24i to swing and a second stimulation module 70i configured for driving the rotary portion 28i to rotate.

The first stimulation module 40i includes a first motor 42i, a swinging unit 44i and a first transmission unit 46i connected between the first motor 42i and the swinging unit 44i. The swinging unit 44i includes a first swinging bar 441i being rotatably mounted into the shell 20i by a first pivot 442i and a second swinging bar 443i being rotatably mounted into the shell 20i by a second pivot 444i. Each of the first and second swinging bars 441i, 443i includes a swinging arm with a distal end being configured as a swinging end 4412i, 4432i and engaged into the swinging portions 24i and a connecting arm with a distal end defining a slot 4414i, 4434i for connecting the swinging unit 44i to the first transmission unit 46i.

The first transmission unit 46i includes a first eccentric wheel 461i and a sliding block 462i. The first eccentric wheel 461i is connected to a rotary shaft 421i of the first motor 42i. The sliding block 462i defines a sliding groove 465i therein, which is strip-shaped and elongated in the Y-direction. A first rod 464i extends outwardly from a periphery of the first eccentric wheel 461i along the X-direction, and slidably engages into the sliding groove 465i. A second rod 466i extends outwardly from the sliding block 462i along the X-direction, and is movably and rotatably engaged into the slots 4414i, 4434i of the first and second swinging bars 441i, 443i.

The second stimulation module 70i includes a driving motor, a rotary shell 74i mounted around the rotary portion 28i, and a second transmission unit 76i connected between the rotary shell 74i and the driving motor. Similar to the second embodiment, the first motor 42i serves as the driving motor of the second stimulation module 70i.

The second transmission unit 76i includes an input wheel 761i connected to the first motor 42i in a transmission way, an output wheel 763i connected to the rotary shell 74i, and several intermediate gears 765i provided between the input wheel 761i and the output wheel 763i. In this embodiment, the input wheel 761i is mounted around and fixed to the first eccentric wheel 461i of the first stimulation module 40i. The intermediate gears 765i are arranged at two end sides of the first motor 42i and connected by an elongated rod 767i.

During operation, the first motor 42i drives the first rod 464i to revolve round the rotary shaft 421i, the sliding block 462i is thus driven to do reciprocating movement in the Z-direction, which in turn drive the first and second swinging bars 441i, 443i to swing about the corresponding pivots 442i, 444i, respectively. Accordingly, the swinging portions 24i are driven o swing towards or away from each other. At the same time, the first motor 42i drives the rotary shell 74i to rotate through the second stimulation module 70i therebetween, which in turn makes the rotary portion 28i rotate therewith. Thus, the swinging portions 24i and the rotary portion 28i simultaneously act on the male genitalia in different ways, providing a better sexual experience for the users.

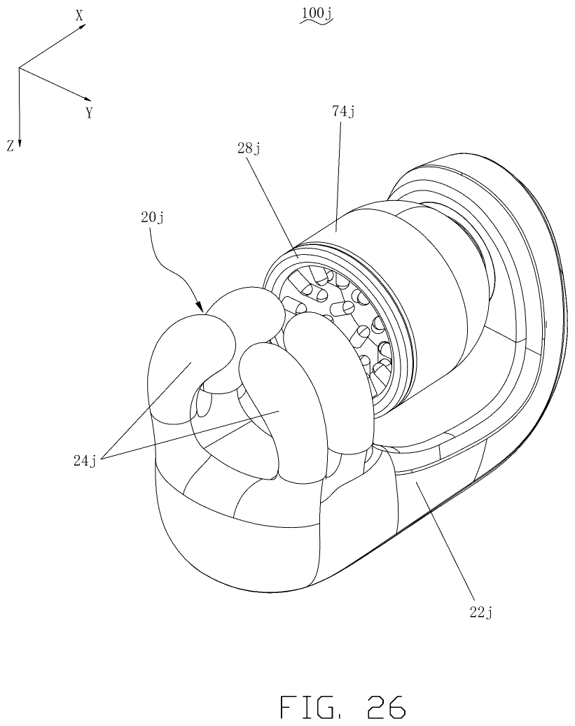

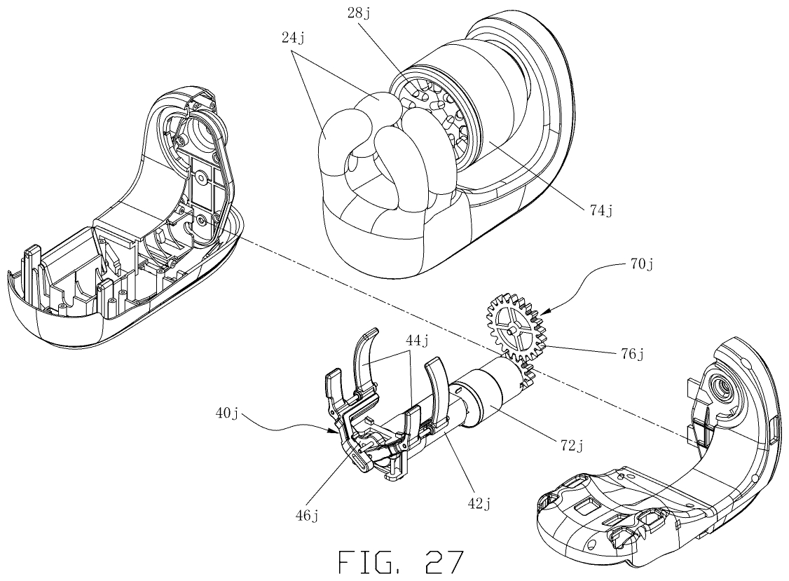

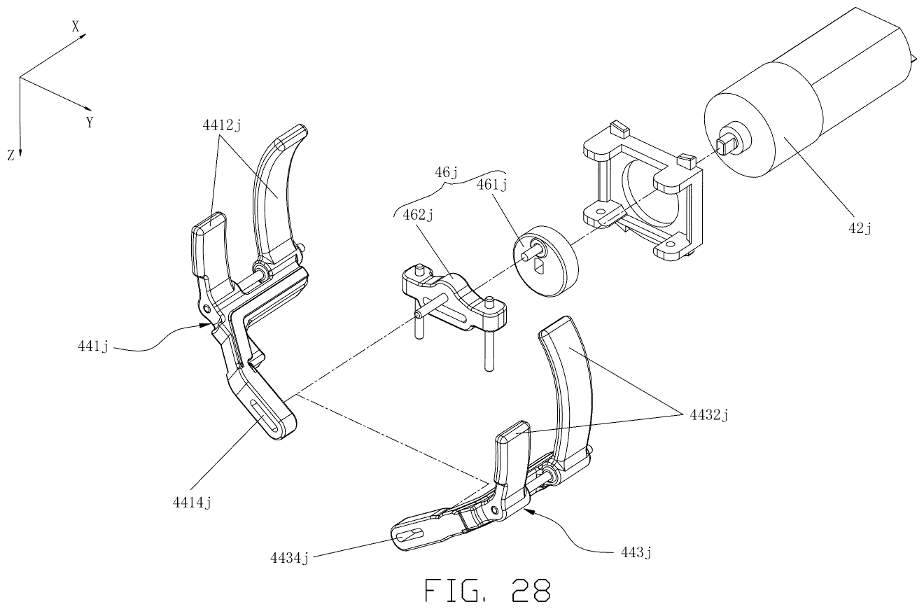

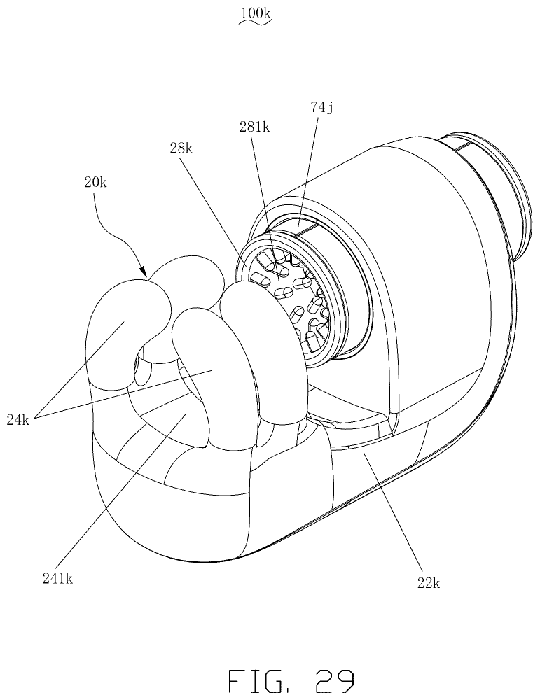

Referring to FIGS. 26-28, a male sexual stimulation device 100j according to a fourth embodiment of the present application is shown. The male sexual stimulation device 100j includes a shell 20j and a stimulation assembly mounted in the shell 20j.

Similar to the second and third embodiments, the shell 20j includes a main portion 22j, a plurality of swinging portions 24j provided at two opposite sides of the main portion 22j and a rotary portion 28j provided at an axial end of the swinging portions 24j. The stimulation assembly includes a first stimulation module 40j configured for driving the swinging portions 24j to swing and a second stimulation module 70j configured for driving the rotary portion 28j to rotate.

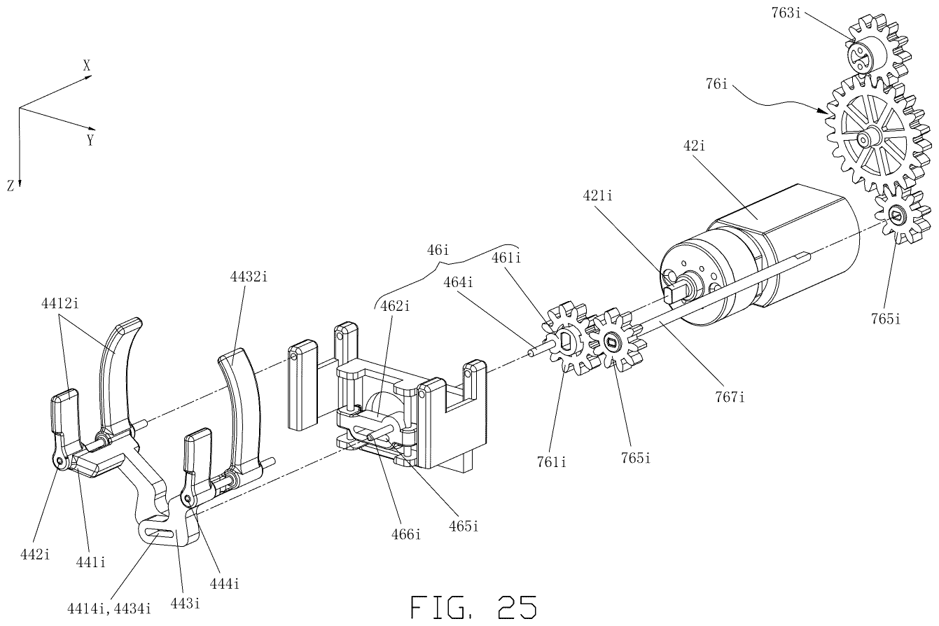

In this embodiment, the first stimulation module 40j includes a first motor 42j, a swinging unit 44j and a first transmission unit 46j connected between the first motor 42j and the swinging unit 44j. The transmission unit 46j includes a first eccentric wheel 461j and a sliding block 462j cooperating with the first eccentric wheel 461j, which is similar to the transmission unit 46i in the third embodiment (referring to FIG. 25), and details will not be repeated here.

The swinging unit 44j includes a first swinging bar 441j and a second swinging bar 443i which are substantially arranged symmetric to each other. Each of the first and second swinging bars 441j, 443j includes a swinging arm with a distal end being configured as a swinging end 4412j, 4432j and engaged into the swinging portions 24j and a connecting arm with a distal end defining a slot 4414j, 4434j for connecting the swinging unit 44j to the first transmission unit 46j.

The second stimulation module 70j includes a driving motor 72j, a rotary shell 74j mounted around the rotary portion 28j, and a second transmission unit 76j connected between the rotary shell 74j and the driving motor 72j. The second transmission unit 76j includes a plurality of gears meshed with each other. That is, the swinging portions 24j and the rotary portion 28j are driven by the first motor 42j and the driving motor 72j, respectively. A connection between the rotary portion 28j and the driving motor 72j may be simplified.

Further, the motion of the swinging portions 24j or the rotary portion 28j can be controlled separately. Specifically, the swinging portions 24j may be driven to swing while the rotary portion 28j remains stationary; or, the rotary portion 28j may be driven to rotate while the swinging portions 24j remain stationary. It should be understood that the first motor 42j may be started to drive the swinging portions 24j to swing, and at the same time, the driving motor 72j may be started to drive the rotary portion 28j to rotate. Therefore, the male sexual stimulation device 100j of this embodiment is more convenient to use.

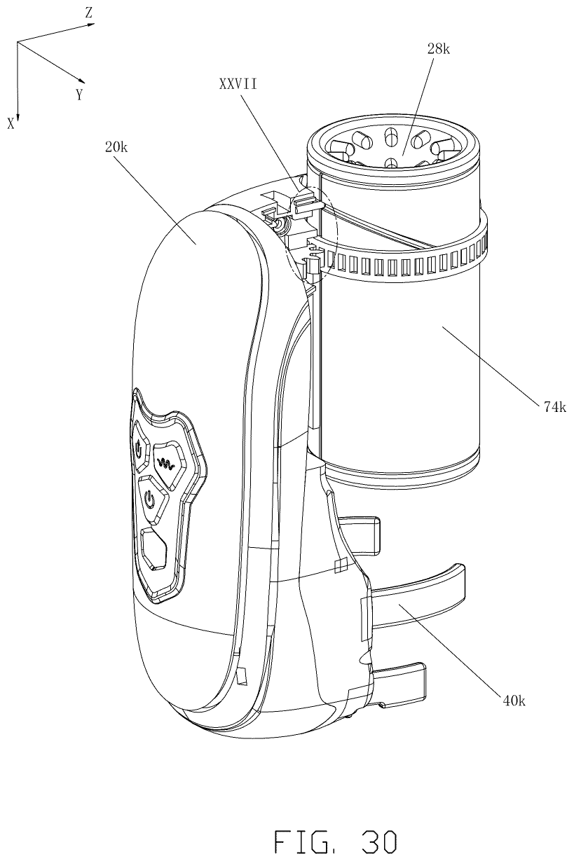

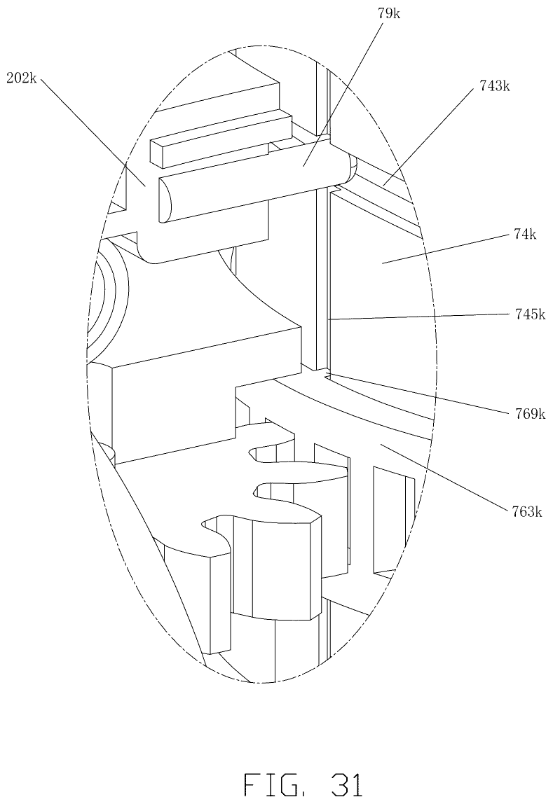

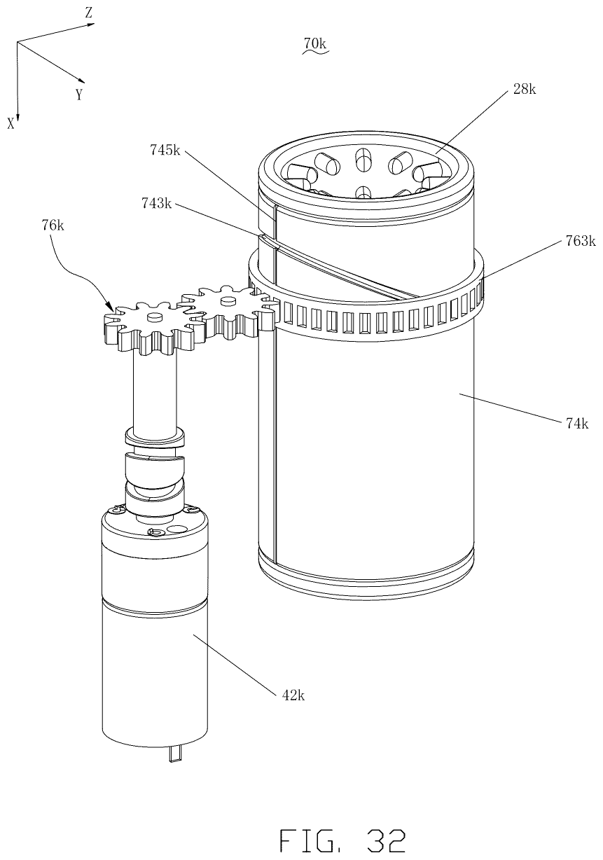

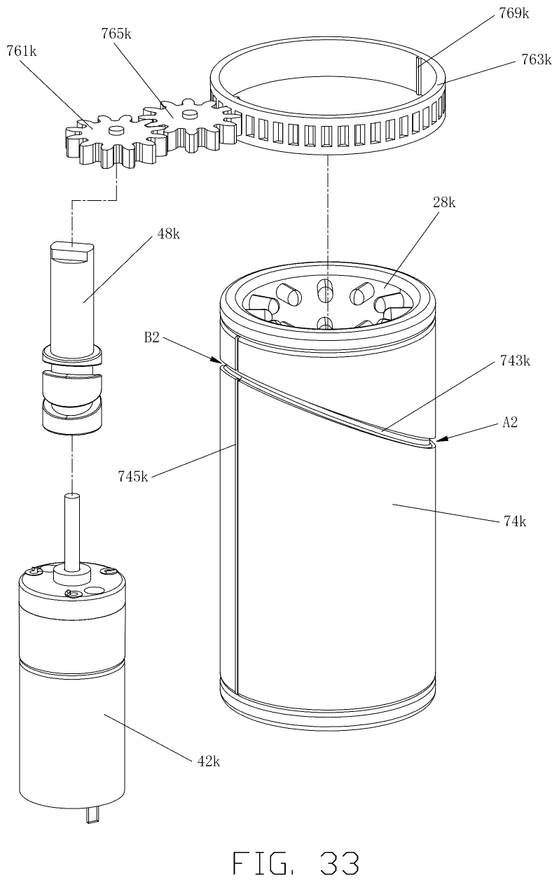

Referring to FIGS. 29-33, a male sexual stimulation device 100k according to a fifth embodiment of the present application is shown. The male sexual stimulation device 100k includes a shell 20k and a stimulation assembly mounted in the shell 20k.

The shell 20k includes a main portion 22k, a plurality of swinging portions 24k provided at two opposite sides of the main portion 22k, respectively, and a rotary portion 28k provided at an axial end of and spaced from the swinging portions 24k. In this embodiment, the rotary portion 28k is cylindrical-shaped with two axial ends thereof being open. Thus, the male genitalia may extend through a first inner chamber 241k between the swinging portions 24k into a second inner chamber 281k in the rotary portion 28k, or extend through the second inner chamber 281k in the rotary portion 28k into the first inner chamber 241k between the swinging portions 24k.

The stimulation assembly includes a first stimulation module 40k configured for driving the swinging portions 24k to swing and a second stimulation module 70k configured for driving the rotary portion 28k to rotate and slide. The first stimulation module 40k is generally the same as the first stimulation module 40h in the second embodiment (referring to FIGS. 18-20), which will not be described again here.

In this embodiment, the second stimulation module 70k includes a driving motor, a rotary shell 74k mounted around the rotary portion 28k, and a second transmission unit 76k connected between the rotary shell 74k and the driving motor. Preferably, the first motor 42k of the first stimulation module 40k serves as the driving motor of the second stimulation module 70k.

The second transmission unit 76k includes an input wheel 761k connected to the first motor 42k in a transmission way, such as through a rotary member 48k of the first stimulation module 40k, an output wheel 763k mounted around the rotary shell 74k, and one or more intermediate gears 765k provided between the input wheel 761k and the output wheel 763k.

A third sliding groove 743k is formed on an outer wall of the rotary shell 74k. The third sliding groove 743k extends spirally in the circumferential direction of the rotary shell 74k. A fixed pin 79k is provided inside the shell 20k, preferably fixed to an inner shell 202k. The fixed pin 79k is slidably engaged into the third sliding groove 743k of the rotary shell 74k. When the rotary shell 74k is driven to rotate, the fixed pin 79k slides along the third sliding groove 743k, causing the rotary shell 74k as well as the rotary portion 28k to move back and forth in the X-direction, further enhancing its stimulation effect.

The third sliding groove 743k is configured to be symmetrical, including two spiral segments extending in opposite directions from a second proximal end A2 to a second distal end B2. In this embodiment, the second proximal end A2 and the second distal end B2 are spaced apart by a certain distance in the axial direction. A span of each spiral segment of the third sliding groove 743k in the circumferential direction is half a circle.

During sliding of the fixed pin 79k along the third sliding groove 743k from the second proximal end A2 to the second distal end B2, the rotary portion 28k slides towards the swinging portions 24k along the X-direction. During sliding of the fixed pin 79k along the third sliding groove 743k from the second distal end B2 to the second proximal end A2, the rotary portion 28k slides away from the swinging portions 24k along the X-direction.

In this embodiment, the outer wall of rotary shell 74k is further provided with a guide groove 745k extending along the X-direction. An inner wall of the output wheel 763k is protruded with a guide block 769k, which is slidably engaged into the guide groove 745k, so that the linear reciprocating motion of the rotary portion 28k in the X-direction is smooth and stable. The guide groove 745k/guide block 769k may be multiple, evenly spaced in the circumferential direction of the rotary shell 74k/output wheel 763k. In some embodiments, the guide block may be provided on the outer wall of the rotary shell 74k, and correspondingly the guide groove may be provided on the inner wall of the output wheel 763k.

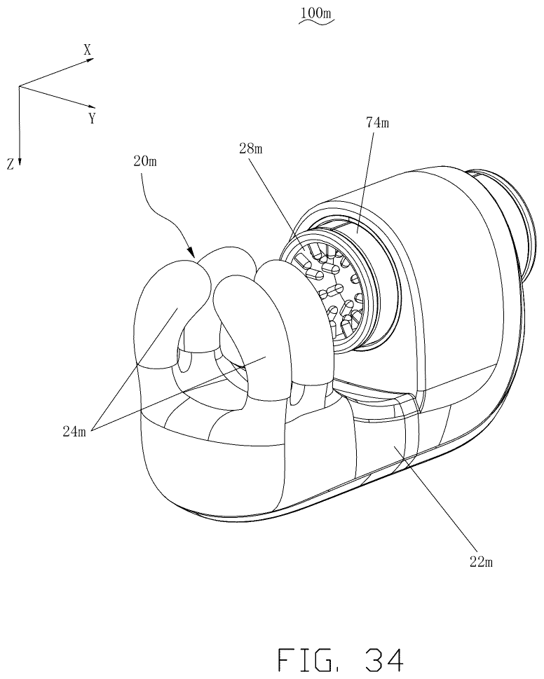

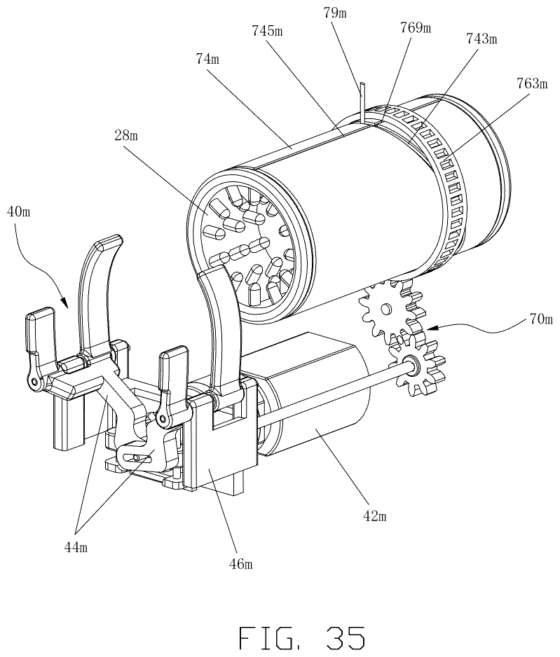

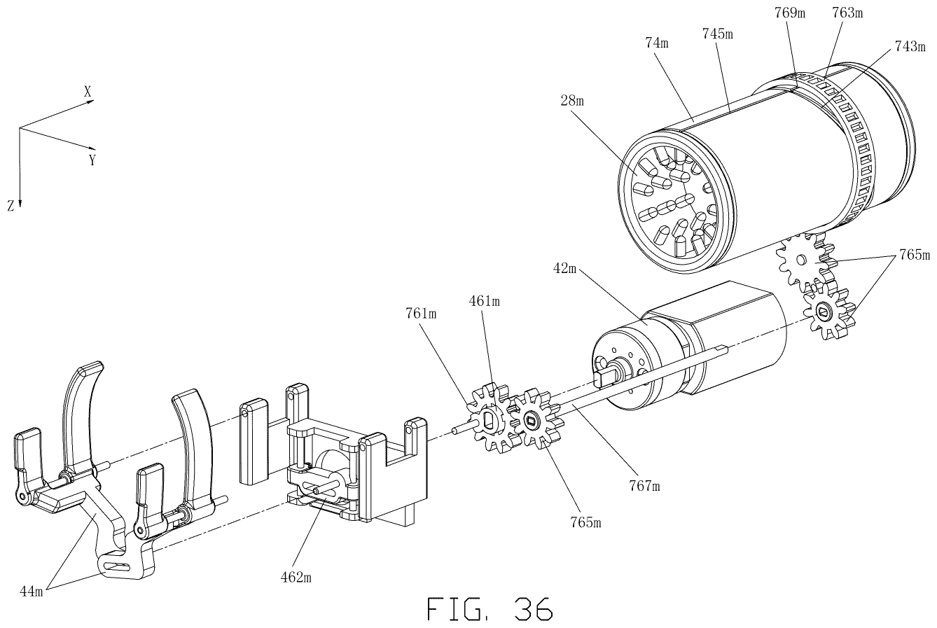

FIGS. 34-36 shows a male sexual stimulation device according to a sixth embodiment of the present application. In this embodiment the male sexual stimulation device 100m includes a shell 20m and a stimulation assembly mounted in the shell 20m.

Similar to the fifth embodiment, the shell 20k includes a main portion 22m, a plurality of swinging portions 24m provided at two opposite sides of the main portion 22m, respectively, and a rotary portion 28m with two axial ends thereof being open provided at an axial end of the swinging portions 24m. The stimulation assembly includes a first stimulation module 40m configured for driving the swinging portions 24m to swing and a second stimulation module 70m configured for driving the rotary portion 28m to rotate and slide.

The first stimulation module 40m includes a first motor 42m, a swinging unit 44m and a first transmission unit 46m connected between the first motor 42m and the swinging unit 44m. The transmission unit 46m includes a first eccentric wheel 461m and a sliding block 462m cooperating with the first eccentric wheel 461m, which is similar to the transmission unit 46i in the third embodiment (referring to FIG. 25), and details will not be repeated here.

The second stimulation module 70m includes a driving motor, a rotary shell 74m mounted around the rotary portion 28m, and a second transmission unit 76m connected between the rotary shell 74m and the driving motor. Preferably, the first motor 42m of the first stimulation module 40m serves as the driving motor of the second stimulation module 70m.

In this embodiment, the second transmission unit 76m includes input wheel 761m mounted around and fixed to the first eccentric wheel 461m of the first transmission unit 46m, an output wheel 763m mounted around the rotary portion 28m, and intermediate gears 765m provided between the input wheel 761m and output wheel 763m. The intermediate gears 765m are arranged at two end sides of the first motor 42m and connected by an elongated rod 767m.

The rotary shell 74m is configured with a spiral-shaped third sliding groove 743m extending in the circumferential and a guide groove 745m extending in the X-direction. A fixed pin 79m is provided inside the shell 20m and slidably engaged into the third sliding groove 743m. Cooperation of the fixed pin 79m and the third sliding groove 743m makes the rotary shell 74m and the rotary portion 28m be able to move in the X-direction during rotation. A guide block 769m is provided on an inner wall of the output wheel 763m of the second transmission unit 76m and slidably engaged into the guide groove 745m. Cooperation of the guide block 769m and the guide groove 745m makes the movement of the rotary shell 74m and the rotary portion 28m in the X-direction be smooth and stable.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A male sexual stimulation device comprising:
a first stimulation part comprising at least two swinging portions being opposite to each other, a first chamber being defined between the at least two swinging portions;
a second stimulation part comprising a rotary portion defining a second chamber therein, the first chamber and the second chamber communicating with each other and cooperatively forming an accommodating space for receiving a male genitalia therein; and
a stimulation assembly connected to the at least two swinging portions and the rotary portion in a transmission way, configured for driving the at least two swinging portions to swing towards or away from each other and driving the rotary portion to rotate.

2. The male sexual stimulation device according to claim 1, wherein a vibration motor is mounted in the first stimulation part.

3. The male sexual stimulation device according to claim 1, wherein each of the at least two swinging portions is configured as a curved column.

4. The male sexual stimulation device according to claim 1, wherein a vibration motor is embedded in the rotary portion.

5. The male sexual stimulation device according to claim 1, wherein a plurality of protrusions is provided on an inner wall of the rotary portion.

6. The male sexual stimulation device according to claim 1, wherein the stimulation assembly comprises a driving motor and a rotary shell connected to the driving motor in a transmission way, the rotary shell is mounted around and fixed to the rotary portion, and a hardness of the rotary shell is higher than that of the rotary portion.

7. The male sexual stimulation device according to claim 6, wherein the stimulation assembly further comprises a transmission unit provided between the driving motor and the rotary shell, and the transmission unit comprises an input wheel connected to the driving motor and an output shell connected to the rotary shell.

8. The male sexual stimulation device according to claim 7, wherein the output shell is mounted around the rotary shell, an outer wall of the rotary shell is provided with a sliding groove which extends spirally in a circumferential direction of the rotary shell, and a fixed pin which is fixed inside the male sexual stimulation device is slidably engaged into the sliding groove of the rotary shell.

9. The male sexual stimulation device according to claim 8, wherein the outer wall of the rotary shell is provided with a guide groove which extends along an axial direction of the rotary shell, and a guide block is provided on the output shell and slidably engaged into the guide groove.

10. The male sexual stimulation device according to claim 7, wherein the rotary portion is cylindrical-shaped, and the second chamber extends through two axial opposite ends of the rotary portion.

11. The male sexual stimulation device according to claim 7, wherein the rotary portion is cylindrical-shaped, an axial end of the rotary portion adjacent to the at least two swinging portions is open, and another end of the rotary portion away from the at least two swinging portions is closed.

12. The male sexual stimulation device according to claim 11, wherein a shaft seat extends outwardly from the rotary shell, and a central shaft of the output wheel is inserted into the shaft seat.

13. The male sexual stimulation device according to claim 7, wherein the stimulation assembly further comprises a swinging unit and another transmission unit connected between the driving motor and the swinging unit, the swinging unit comprises at least two swinging ends extending into the at least two swinging portions, respectively.

14. The male sexual stimulation device according to claim 13, wherein the another transmission unit comprises an eccentric wheel driven by the driving motor and a sliding block cooperating with the eccentric wheel to convert rotation of the driving motor into reciprocating linear movement of the sliding member, and the input wheel is connected to the driving motor through the eccentric wheel.

15. The male sexual stimulation device according to claim 13, wherein the another transmission unit comprises a rotary member driven by the driving motor, a sliding member and a fixed member, the fixed member defines a first sliding groove extending along an axial direction of the rotary member, the rotary member defines a second sliding groove extending spirally along a circumferential direction of the rotary member, and the sliding member comprises a first sliding block being slidably engaged into the first sliding groove and a second block being slidably engaged into the second block, and the input wheel is connected to the driving motor through the rotary member.

16. The male sexual stimulation device according to claim 6, wherein the stimulation assembly further comprises another driving motor, a swinging unit and a transmission unit connected between the another driving motor and the swinging unit, and the swinging unit comprises at least two swinging ends extending into the at least two swinging portions, respectively.

17. A male sexual stimulation device comprising:
a shell comprising a main body, two first stimulation portions extending from two opposite sides of the main body, respectively, and a second stimulation portion being provided at end of the two first stimulation portions;
a first chamber being defined between the two first stimulation portions, a second chamber being defined in the second stimulation portion, the first chamber and the second chamber communicating with each other and cooperatively forming an accommodating space for receiving a male genitalia therein; and
a stimulation assembly mounted in the shell, configured for driving the two first stimulation portions to move towards or away from each other, and, configured for driving the second stimulation portion to rotate.

18. The male sexual stimulation device according to claim 17, wherein the stimulation assembly is further configured for driving the second stimulation portion to do reciprocating movement.

19. The male sexual stimulation device according to claim 17, wherein the stimulation assembly is configured for driving the two first stimulation portions to swing towards or away from each other.

20. The male sexual stimulation device according to claim 17, wherein a vibration motor is provided in the two first stimulation portions and/or the second stimulation portion.
